(19) United States
(12) Patent Application Publication
(10) Pub. No.: US 2023/0154187 A1
(43) Pub. Date: May 18, 2023

(54) METHOD OF DECOMPOSING A LECTURE INTO EVENTS

(71) Applicants: Kelsey L Bruso, Eagan, MN (US); Mangesh Walsatwar, Bengaluru Karntaka (IN); Ramkumar M., Telangana (IN); George S., Telangana (IN)

(72) Inventors: Kelsey L Bruso, Eagan, MN (US); Mangesh Walsatwar, Bengaluru Karntaka (IN); Ramkumar M., Telangana (IN); George S., Telangana (IN)

(73) Assignee: Unisys Corporation, Blue Bell, PA (US)

(21) Appl. No.: 17/525,073

(22) Filed: Nov. 12, 2021

(51) Int. Cl. G06K 9/00; G06Q 50/20

(52) U.S. Cl. CPC G06K 9/00718; G06K 9/00765; G06Q 50/20; G06K 2009/00738

(57) ABSTRACT

A method of decomposing a lecture into events includes: processing a recorded video and segmenting the video into video, chat, audio and audio transcript; processing the video and dividing it into discreet events including lecture, green board text, white board text, and interaction with users; and storing the discreet events as a storyboard that identifies break points in the lecture. The storyboard and events can be used to create a composed lecture.

### FIELD OF THE DISCLOSURE

The present application relates generally to virtual classrooms, and more particularly to methods and systems of providing an interactive learning experience in a virtual classroom.

### BACKGROUND

Video is widely used around the world for video conferences, sharing of information and collaboration. Video is also used for classroom models. However, current classroom models have drawbacks including social isolation. i.e., the student may only see the teacher. Other students in the class may not have turned on their cameras. Another drawback is any language barrier, for example, the teacher may speak Kannada while the student speaks Portuguese. Another drawback is there is no context for the teacher or student surroundings. And, there is no ability to look around in the space as one could in a traditional classroom. Therefore, improvements are desirable.

### SUMMARY

In a first aspect of the present invention, a method of decomposing a lecture into events includes: processing a recorded video and segmenting the video into video, chat, audio and audio transcript; processing the video and dividing it into discreet events including lecture, green board text, white board text, and interaction with users; and storing the discreet events as a storyboard that identifies break points in the lecture. The storyboard and events can be used to create a composed lecture.

In a second aspect of the present invention, a computer program product includes a non-transitory computer readable medium comprising instructions which, when executed by a processor of a computing system, cause the processor to perform the steps of: processing a recorded video and segmenting the video into video, chat, audio and audio transcript; processing the video and dividing it into discreet events including lecture, green board text, white board text, and interaction with users; and storing the discreet events as a storyboard that identifies break points in the lecture.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the disclosed system and methods, reference is now made to the following descriptions taken in conjunction with the accompanying drawings.

FIG. 1 is a block diagram illustrating a virtual classroom model, according to one example embodiment of the present invention;

FIG. 2 is a block diagram illustrating a virtual classroom model, according to one example embodiment of the present invention;

FIG. 3A is an illustration of a virtual classroom, according to one example embodiment of the present invention;

FIG. 3B is an illustration of a teacher in a virtual classroom, according to one example embodiment of the present invention;

FIG. 3C is an illustration of an avatar of a student in a virtual classroom, according to one example embodiment of the present invention;

FIG. 3D is an illustration of other students in a virtual classroom, according to one example embodiment of the present invention:

FIG. 3E is an illustration of a studious in a virtual classroom, according to one example embodiment of the present invention;

FIG. 4A is an illustration of a chat function of a virtual classroom, according to one example embodiment of the present invention;

FIG. 4B is an illustration of a green board of a virtual classroom, according to one example embodiment of the present invention;

FIG. 4C is an illustration of a white board of a virtual classroom, according to one example embodiment of the present invention;

FIG. 4D is an illustration of a student's desk in a virtual classroom, according to one example embodiment of the present invention;

FIG. 4E is an illustration of a bookshelf in a virtual classroom, according to one example embodiment of the present invention;

FIG. 5 is a flow diagram of a time shifting function of a virtual classroom, according to one example embodiment of the present invention;

FIG. 6 is a flow diagram of a storyboard creation, according to one example embodiment of the present invention;

FIG. 7 is a flow diagram of a translation function of a virtual classroom, according to one example embodiment of the present invention;

FIG. 8 is a flow diagram of an assessment in a virtual classroom, according to one example embodiment of the present invention;

FIG. 9 is a block diagram illustrating a computer network, according to one example embodiment of the present invention; and

FIG. 10 is a block diagram illustrating a computer system, according to one example embodiment of the present invention.

### DETAILED DESCRIPTION

In general, the present disclosure is about an Interactive Virtual Classroom (IVC). The IVC is a 3D virtual, immersive environment of learning. The IVC seeks to mimic the traditional classroom experience in a virtual world. The IVC preferably includes a teacher, a scholar taking the class, other students in the class and a tutor. The IVC also includes a chat feature, a white board, a bookshelf, and green or black board, and a teacher presence. The IVC also includes time-shifting, translational capabilities, storybook creation for creating composed lectures and assessments of the student.

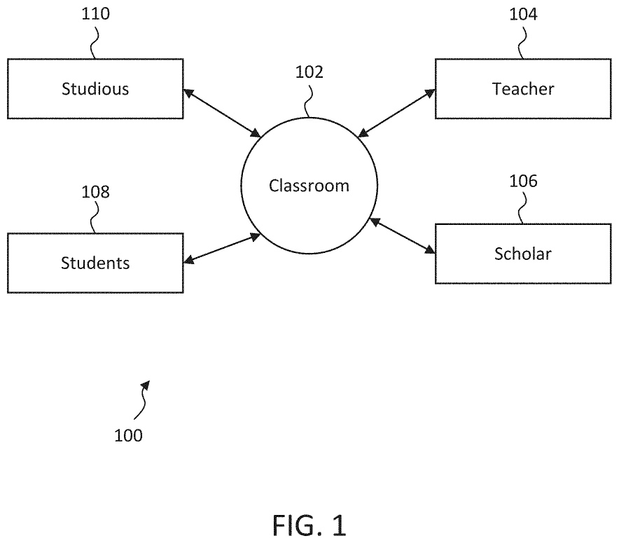

Referring to FIG. 1, an IVC 100 has several actors interconnected through a classroom 102. The classroom 102 is the virtual location where learning occurs. The classroom 102 can have a traditional 4-walls look and feel. The look and feel of the classroom 102 is preferably configurable by the user. It can be in any setting and can be any look and feel. For example, the classroom 102 can be traditional, an outdoor location, on the moon, under the sea, in a forest, etc.

The actors or participants of the IVC 100 include a teacher 104, a scholar (the student) 106, other students 108 and a studious 110. The teacher 104 leads the education or training session. By default, the teacher 104 can be portrayed, perhaps directly form a recorded video, speaking to the class in a standard interaction way. The look and feel can be configured differently. For example, the teacher 104 could be a chosen avatar, celebrity likeness, an animation or an animal. The teacher 104 position could also be selected and configured, including in the front of the class or sitting with the class.

The scholar 106 is the student taking the class. The other students 108 are zero or more other students who appear in the classroom 102 in addition to the scholar 106. The scholar 106 or students 108 could also be real pictures or video or could be selected avatars. The scholar 106 can also select whether or not to see the other students 108. The scholar 106 can be presented in the first-person video such that the scholar 106 does not see herself in the classroom 102—only the teacher 104 and other students 108—or just the teacher 104. The scholar 106 could also be presented in the third-person view such that the scholar 106 also sees herself in the classroom 102.

The studious 110 is the scholar's 106 personalized chatbot or tutor. The scholar 106 may configure the studious 110 according to personal style. The studious 110 monitors the lecture and can answer the scholar's 106 questions in lieu of the teacher 104. The scholar 106 can train the studious 106 and teach it new information, and through artificial intelligence, the studious can learn and gain knowledge. As the studious 110 instance travels from class to class with the scholar 106, it gains additional information and skills. The scholar 106 can choose the language of the studious 110, the avatar and how it interacts (e.g., through cartoon strip balloons). The studious 110 can interact with the scholar 106 to determine if the scholar 106 understands the materials, if they are listening and engaged, if they need a break, may proctor an exam or prepare the scholar 106 for an exam. The studious 110 could also serve as the teacher's 104 assistant.

The IVC 100 allows the scholar 106 to customize the learning experience. For example, the scholar 106 can change the classroom setting, the language, the teacher position, the teacher avatar, scholar avatar, student avatar, whether students are shown or not shown, look and feel of the classroom objects and first or third-person perspective. These settings can be established for a chosen duration, i.e., this lecture, this course, all courses for this scholar 106 or all courses for this teacher 104.

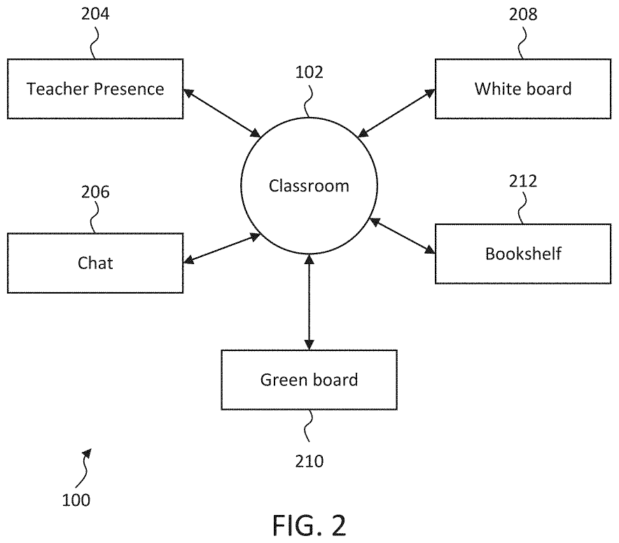

Referring to FIG. 2, the IVC 100 has several objects related to the classroom 102 including a teacher presence 204, a class chat 206, a white board 208, a green board 210 and a bookshelf 212. The types, positioning in the space and number of each can be configured by the teacher 104 or the scholar 106 according to individual preferences. The teacher presence 204 is preferably projected from the front of the classroom 202 in a traditional classroom arrangement, but can be configured as desired. The class chat 206 fields questions or comments that can be seen by the scholar 106, students 108, teacher 104 and studious 110. The white board 208 is scratch space where the teacher 104 can post text, code snippets, PDFs, PPTs, JPGs, videos or other items.

The green board 210 has a traditional look and feel of a black board or green board where the teacher 104 can write information to illustrate a point. The bookshelf 212 has the traditional look and feel of a bookshelf that the teacher 104 may pre-populate with resource materials including books, PDFs, PPTs, videos, audio recordings and other items. The bookshelf contains links to the resources. The scholar 106 and students 108 may add additional materials to the bookshelf 212 as desired. The bookshelf 212 can also be segregated into shared and personal portions. In addition, the IVC 100 can handle any digital rights management necessary for any object put into the bookshelf 212.

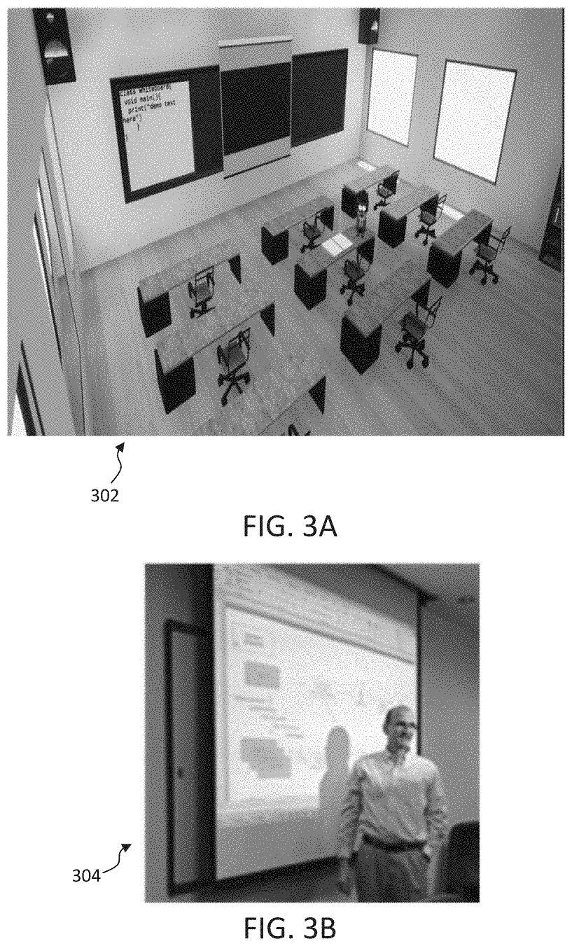

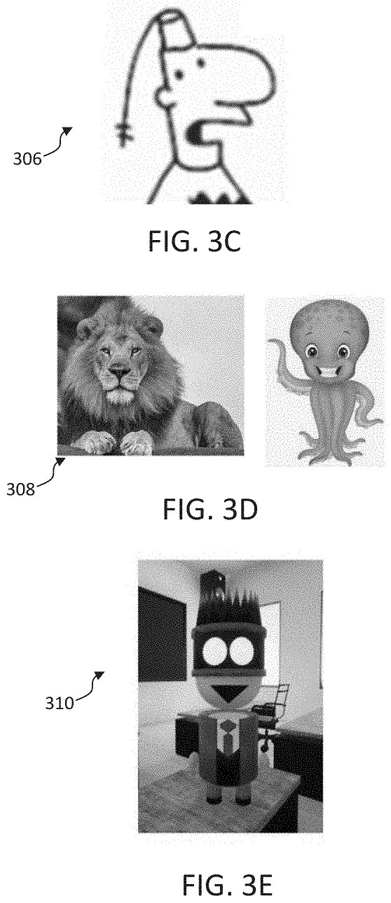

Referring to FIGS. 3A-3E, in FIG. 3A, a typical classroom 302 is illustrated. In FIG. 3B, a teacher 304 in real video is illustrated in the front of the classroom. In FIG. 3C, the scholar 306 is illustrated as an animated avatar. In FIG. 3D, other students 308 are illustrated, one as an animal avatar and one as an animated avatar. In FIG. 3E, the studious 310 is illustrated as an avatar.

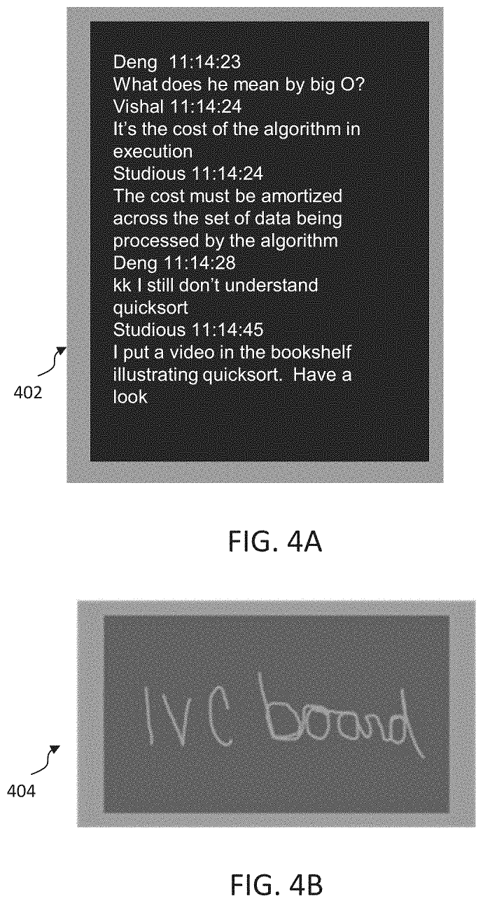

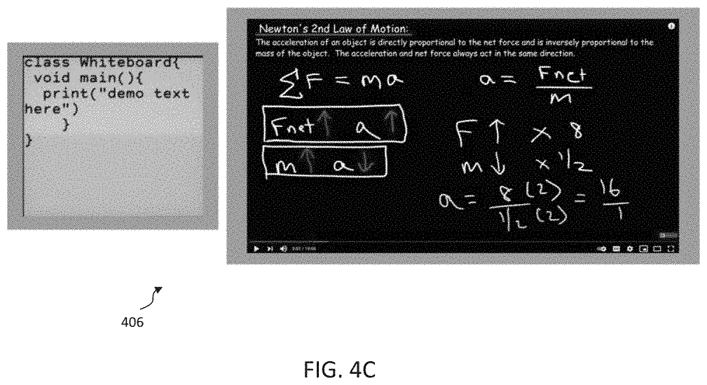

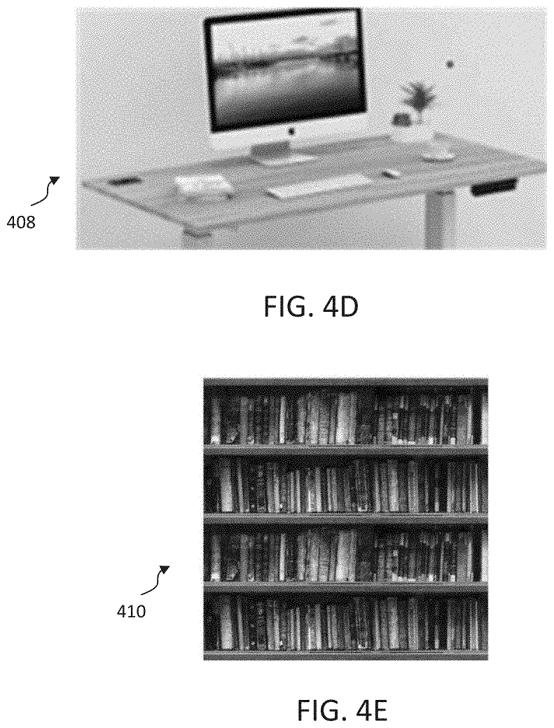

Referring to FIGS. 4A-4E, in FIG. 4A, a chat window concept 402 is illustrated. Here, questions, comments, etc. can be seen by the scholar 106, all students 108, the teacher 104 and the studious 110. In FIG. 4B, a black board or green board concept 404 is illustrated. The green board concept 404 has the traditional look and feel of a black board or green board where the teacher 104 can write information to illustrate a point. In FIG. 4C, a white-board 406 is illustrated. This is scratch space where the teacher 104 can post text, code, snippets, PDFs, PPTs, JPGs, videos and other multi-media items, etc. The teacher 104 can create a new white-board for each illustration or can reuse an existing white-board with new content.

In FIG. 4D, a desktop 408 is illustrated. This is the scholar's 106 work surface. The placement, shape and texture of the desktop is configurable by the scholar 106 and can include any object. Objects to appear on the desktop, e.g. monitor, photo, studious, etc., are configurable by the scholar 106. In FIG. 4E, a bookshelf 410 is illustrated. This is a collection of the digital resources available to the class. The objects of FIGS. 4A-4E can appear as separate objects or as windows, portals or posterns in a larger canvas. The teacher 104 can configure zero, one or many instances of each to support the needs of the educational experience. The objects may appear on the wall, float in space, appear on the desktop, etc. according to the scholar's 106 choice.

Preferably, the IVC 100 supports and adapts to the scholar's 106 interaction mechanism. The IVC 100 can adapt to an augmented reality (AR) or virtual reality (VR) headset for the most immersive experience. The IVC 100 can adapt to a moveable device such as a tablet or phone to see side-to-side and up-and-down; it can adapt to one or more monitors whose displayed content can be moved or scrolled left, right, up, down—either independently or together—to navigate around the virtual environment. Multichannel audio is used to position the source of the audio, e.g., teacher speaking according to the student's current orientation in the classroom space: above, below, ahead, behind, left, right etc.

Preferably, the IVC 100 experience is independent of time. It can be a live session with a teacher 104, the student 106, and other students 108 participating in the class simultaneously. It can also be a composed session with a teacher 104, the student 106 and other students 108 created by the IVC 100 using previous live modes or composed modes. The IVC 100 allows time shifting, real-time, delayed time, catch-up time (which is not akin to “fast forwarding). A student 106 can join the session late and watch in a delay or accelerated time to catch-up to live. The student 106 can watch later in a passive playback of the class as well.

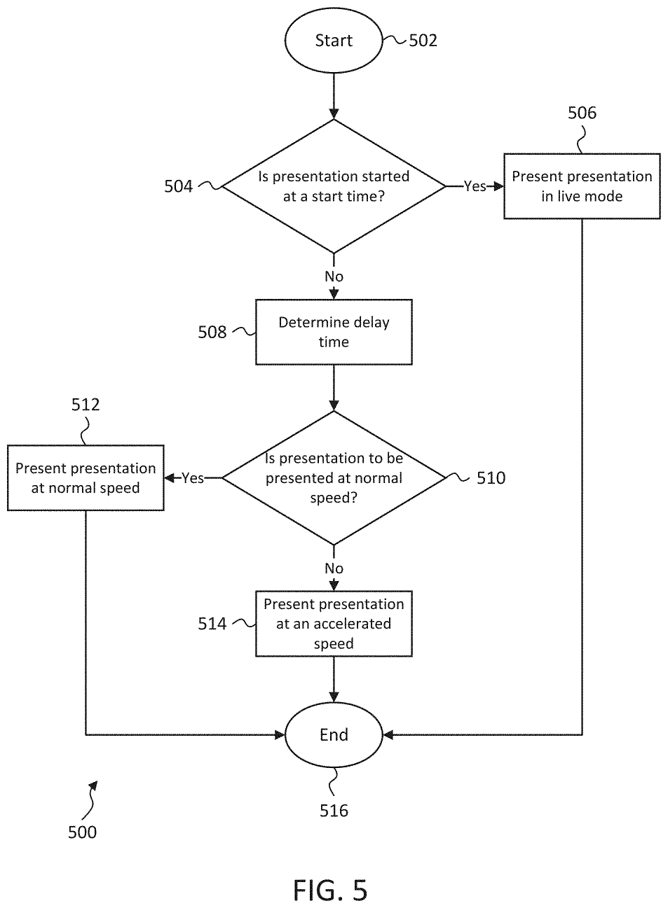

Referring to FIG. 5, a method 500 of presenting a virtual class is illustrated. Flow begins at 502. At 504, the IVC 100 determines if the presentation started at a start time. If the IVC 100 determines the presentation did start at the start time, flow proceeds “YES” to 506 and the presentation is presented in live mode. Flow ends at 516. At 504, if the IVC 100 determines the presentation did not start at the start time, flow proceeds “NO” to 508 and the IVC determines the delay time. At 510, the IVC 100 determines if the presentation is to be presented at normal speed. If the IVC determines the presentation is to be presented at normal speed, flow branches “YES” to 512 to the presentation is presented at the normal speed. In this case, the presentation will end at an end time plus the delay time. Flow ends at 516. At 510, if the IVC 100 determines the presentation is not to be presented at normal speed, then flow branches “NO” to 514 and the presentation is presented at an accelerated speed. In this case, the presentation will end at the end time. Flow ends at 516.

As such, the student can decide to view the presentation in live mode from the start time to the end time. The student could also join late and view the presentation in normal time and finish at an end time plus the delay time. The student could also join late and choose to “catch-up” with the lecture such that the lecture still ends on time. In this matter, the playback is accelerated such that by the end time, the lecture has fully played. Of course, the student could also join, and decide to skip the portion missed. The student can also pause at any time and then make a variation of the above to skip a portion, watch longer or catch-up.

A composed mode format is unique to the IVC 100. After a live session, the IVC 100 produces a storyboard containing a sequence of events. Video segments and corresponding transcripts are produced. In addition green-board, white-board and bookshelf artifacts are produced. When, the scholar 106 chooses a lecture for a composed mode session, the IVC 100 creates a unique composed mode session using these existing storyboard and artifacts. The scholar's 106 interaction during the composed mode session creates additional events and artifacts which are then available for future composed mode sessions.

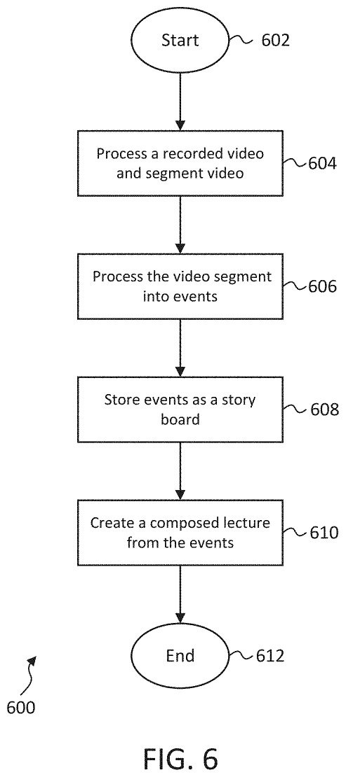

Referring to FIG. 6, a method 600 of decomposing a lecture into events is illustrated. Flow begins at 602. At 604, the IVC 100 processes a recorded video and segments the video into video, audio, transcripts, etc. At 606 the IVC 100 processes the video segments into discreet events. At 608, the IVC 100 stores the event in order in a storyboard. At 610, the IVC 100 creates a composed lecture from the events. Flow ends at 612.

In one example embodiment, the teacher 104 records a class session to video. The IVC 100 processes the video and divides it into the following channels: video, chat, audio and audio transcript. Using artificial intelligence, the IVC 100 process the video and divides it into events, such as lecture, write on green board, show illustration on white board, answer a scholar's question, new entry into the chat, etc. The IVC 100 divides it into sentences and concepts. The results are stored as the storyboard. The storyboard events identify break points in the session, for example, for when a scholar 106 can ask a question. The IVC 100 processes the video and extracts the chat and green-board and white-board content. It coordinates the sequencing and timing of these with the storyboard and pre-populates the bookshelf 212 with this content. The teacher may edit the storyboard or objects extracted from the video. The teacher 104 identifies a text book for the students to use and pre-populates the books shelf 212 with auxiliary materials. The teacher 104 identifies class meta-data. The teacher 104 can identify the course topic, unusual jargon and suggest translations to certain languages.

In one example embodiment, the storyboard drives the composed session. During a composed session, the bookshelf 212 is pre-populated with all available content. The scholar 106 sees the teacher 104 speak in the scholar's chosen language—lips move and word formation happens—and the scholar 106 hears the teacher 104 speak in the chosen language. The scholar 106 may ask a question, post on the class chat 206, add to the bookshelf 212, etc. during the composed session. The IVC 100 interrupts the composed session at the end of an event, recognizes the scholar 106 who then asks her question, generates a response and continues with the storyboard. The scholar's 106 interaction generates new artifacts. A future scholar 106 chooses the same lecture and experiences the composed mode session using the modified storyboard, including the previously posed question from the previous composed mode.

In addition, the IVC 100 also manages extensive translation of spoken and textual information. Each scholar 106 can identify a language of choice in which to interact with the lecture. The IVC 100 presents the teacher avatar speaking in the scholar's 106 chosen language and teacher avatar can be chosen by the scholar 106. The teacher avatar appears to speak—lips move, word formation happens, etc. in the scholar's language of choice.

The IVC 100 performs real-time audio translation of the teacher's 104 language into the scholar's 106 chosen language. The IVC 100 also performs real-time textual transcription of the teacher's 104 language into the scholar's 106 chosen language. The IVC 100 also includes real-time transformation of the video of the teacher's 104 speech into the scholar's 106 chosen language. In other words, the teacher's 104 lips move and word formation appear as though the teacher 104 was speaking in the scholar's 106 chosen language, even though the teacher 104 actually spoke in his/her native language. The IVC 100 also performs real-time transformation and translation of interaction between the students 108 and the scholar 106. The IVC 100 can also translate the materials in the bookshelf 212.

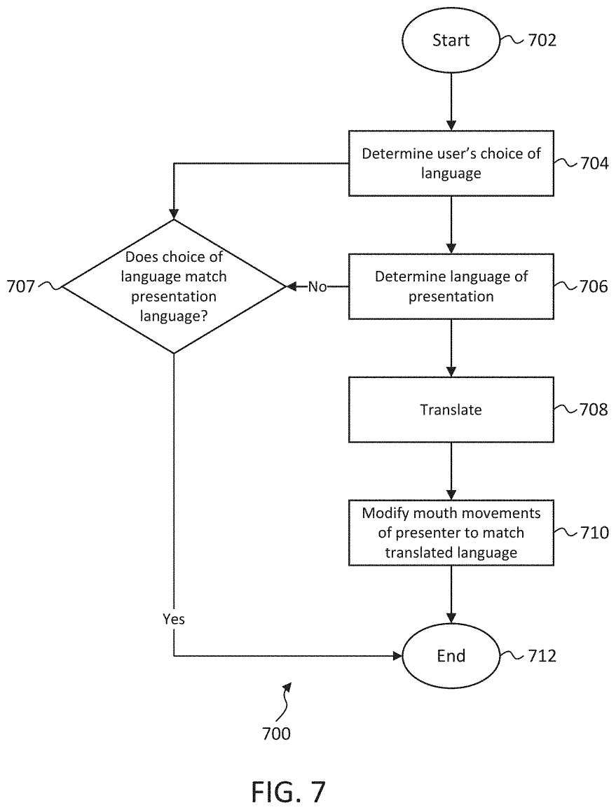

Referring to FIG. 7, a method 700 of presenting a virtual classroom is illustrated. Flow begins at 702. At 704, the IVC 100 determines the user's choice of language, for example Chinese. At 706, the IVC 100 determines the language (by the teacher) of the presentation, for example, Russian. At 707, the IVC 100 determines if the choice of language matches the presentation language. If “YES” flow branches to end at 712. No translation is necessary. At 707, if the IVC 100 determines the languages do not match, flow branches “NO” to 708 and the IVC 100 translates the presentation language, i.e. Russian, into the choice of language, i.e. Chinese. At 710, the IVC 100 modifies the video portion such that the mouth movements of the teacher 104 match the choice of language, i.e. Chinese. Flow ends at 712.

The IVC 100 uses artificial intelligence driven rendering of the video, in conjunction with the chosen avatar, to construct the teacher presence who speaks to the class in the scholar's 106 chosen language. Furthermore, the teacher 104 can see if the student 106 is in real-time, catch-up, delayed or on pause. The teacher 104 can see if the student 106 is in first or third person viewing. The teacher 104 can initiate a private dialogue with the student, either verbally or in transcript or both.

Whatever experience is selected, the student experience is consistent. It is not exactly the same experience because each student 106 can configure the platform according to his/her needs. In composed mode, the IVC 100 draws from previous class session artifacts and events and constructs an educational experience unique for a particular scholar 106. The scholar 106 can pause the class for a break, and then resume or catch-up on the class after the break.

The scholar 106 may initiate an interaction with another student 108 in the class at any time. The interaction can be verbal or textural. The scholar 106 may pause or continue the lecture during the interaction. The scholar 106 provides input in their language of choice. The scholar 106 receives responses back in the language of choice. In live mode, the other student 108 can choose to engage. In composed mode, the IVC 100 may reply with a virtual student 108.

The scholar 106 can also participate in class. In live mode, the scholar 106 can raise her hand to ask a question. The teacher 104 can call on the scholar 106 and answer the question. The other students 108 can hear or see (or both) the question and answer in their language of choice, which can be different for each student. In composed mode, the scholar 106 can also raise her hand to ask a question in the same manner.

The scholar 106 can present the question verbally or via keyboard or other input device in the scholar's 106 language of choice. The IVC 100 can answer in a variety of ways including sending the query to the teacher 104 to answer. The query could also go to a teacher's assistant. The IVC 100 can search the bookshelf 212 for an answer or a document corpus. The internet could also be searched taking into account the context and subject matter jargon. Being able to send the query to the teacher 104 in a composed mode is unique to the IVC 100. When the answer is found, the IVC 100 has the teacher 104 avatar speak the answer. The teacher's prompt and scholar questions go into the lecture video, storyboard and transcript as new events. The answer also does. The new event is available for inclusion in a future composed session. The studious 110 could also answer the question. The scholar 106 and the students 108 may also rate the question/answer event. The events with a higher rating have a higher probability of being included in a future composed session. The scholar 106 may augment the answer by providing an addendum or link to the bookshelf 212.

Course assessments i.e., tests, can be conducted either in live or composed modes. The teacher 104 can train the IVC 100 to evaluate the results such that the teacher 104 does not need to “grade” the tests. The teacher's studious 110 could also be used. The IVC 100 can run in a controlled-mode during assessments and limit the scholar's 106 access to the bookshelf 212, the scholar's 106 personalized studious 110 and other resources. The teacher 104 can monitor the scholar 106 during the assessment and provide grades. Course completion certificates can also be issued based on grades. The IVC 100 can integrate with external platforms and issue course completion badges and/or share on social media platforms.

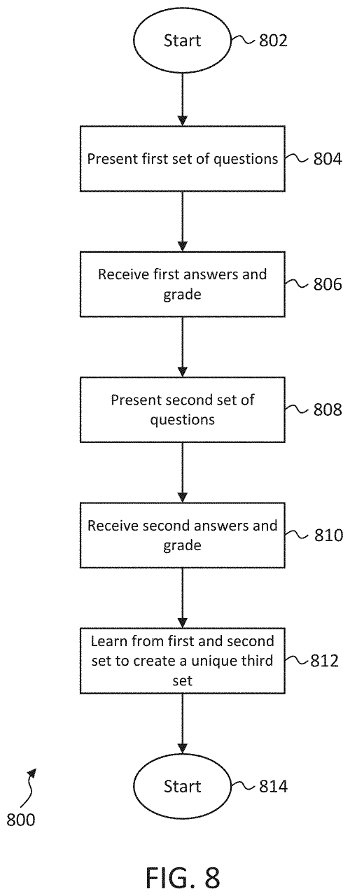

Referring to FIG. 8, a method 800 of assessing aptitude in a virtual classroom is illustrated. Flow beings at 802. At 804, the IVC 100 presents a first set of questions to a first scholar. At 806, the IVC 100 receives the first answers to the first set of questions and grades the answers. At 808, the IVC 100 presents a second set of questions to a second scholar. Preferably, the second set of questions is not the same as the first set of questions. At 810, the IVC 100 receives the second answers to the second set of questions and grades the answers. At 812, in a first embodiment, the IVC 100 learns from the first and second set of questions and answers to create a unique third set of questions. In a second embodiment, the teacher provides the third set of questions. In a third embodiment, the teacher actively oversees the IVC system machine learning, until the system has achieved the desired level of accuracy in independently-created test questions. Flow ends at 814.

The IVC 100 keeps a set of meta-data. In one embodiment, this meta-data includes a course identifier, a lecture identifier and a variant identifier. A course is the overall course, e.g. Physics 101. A lecture is one class in the course, typically identified by a sequence number or a date. A variant is one instance of a class lecture. A new variant may be created each time a student 106 “plays” a lecture in composed mode. The scholar 106 may ask questions or add materials to the book shelf 212, thus generating a new variant of the lecture. Each lecture is composed of one or more events. The meta-data can also include the course topic e.g., physics. The course topic enables customization of the vocabulary for translation of audio to transcript and for translation to the scholar's 106 chosen transcript language and audio language. The meta-data can also include the lecture storyboard and events in the lecture. For each event, the IVC 100 captures the language of the audio, transcript and video.

Another challenge with virtual classrooms is security. The IVC 100 uses authorization and authentication to control student access to a course or lecture. Stealth Identity from Unisys Corporation of Blue Bell, Pa. can be used to implement features of the present disclosure. Stealth can be used to protect the end to end data communications and make the endpoints go dark on the Internet. As with other Stealth applications, not all endpoints require Stealth protection. The IVC 100 uses an encryption and isolation mechanism, such as Stealth Core form Unisys. This can allow or disallow a student to participate in a course or lecture; segregate sets of students into independent groups, based on authorized identify, provide encrypted channels for interaction and allow or disallow a scholar 106 to see or access materials in the bookshelf 112.

In one example embodiment, the scholar 106 chooses a course and a lecture, for example, Banyan Elementary School, Grade 5, Spring 2021, 13 Apr. 2021 lecture. The scholar 106 arrives at 7:55 a.m. and the live session begins at 8:00 a.m. The scholar 106 appears in virtual classroom with the teacher 104 and any other students 108 who have already arrived. The scholar 106 may interact with the teacher 104 and any other students 108 who have arrived. The lecture starts at 8:00. At any time, the scholar 106 may pause and resume the live lecture. In another example, the scholar 106 arrives at 8:05 a.m. and the live session began at 8:00 a.m. The scholar 106 appears in the virtual classroom 102 with the teacher 104 and any other students who have already arrived 108. The scholar 106 can choose between live real-time mode (missing the first 5 minutes of the lecture), live delay mode (finishing the lecture 5 minutes late), or live catch-up mode (seeing the entire lecture and finishing on time).

In another example embodiment, the scholar 106 chooses a course and a lecture for example, Physics 101 Fall 2015, Lecture 3. Because the lecture happened in the past, the playback defaults to composed mode. The IVC 100 selects other students 108 to appear in the classroom 102. The scholar 106 may choose to keep the default students or choose other students who have participated in the class in the past, choose more or fewer students or remove one or all of the students, etc. The scholar 106 may choose an avatar for each of the other students 108 in the classroom 102. During this composed session, the scholar 106 may raise her hand to ask a question to the teacher 104. The IVC 100 generates an answer for the question and animates the teacher 104 to appear to answer the question. The scholar 106 may ask a question or engage in dialog with another student 108 in the class. The IVC 100 animates the engaged student to give the illusion that the other student is present in the classroom 102 simultaneous with the scholar 108. The scholar 106 may ask the studious 110 a question at any time, make use of any materials in the bookshelf 212 at any time, and pause and resume the session. Any questions that the scholar 106 asked become additional events which the IVC 100 may use in future composed sessions.

In another example embodiment, two or more scholars 106 may be viewing a lecture in composed mode at the same time. For example, a team may schedule a composed session (e.g., 5 people in a team want to “take the basic MASM programming class” from 15 Jan. 2021 in a composed mode session). Each of the 5 would have the scholar 106 perspective and personalization capabilities. Each of the 5 would see the other 4 as students 108, and possibly other students chosen by the IVC 100. Each of the 5 could interact in real time while viewing the composed session—asking questions of each other, posting questions or answers in the Class Chat, adding materials to the Book Shelf, and so on. Each of these five experience would be different and each could generate new events or artifacts for possible inclusion in future composed sessions. The IVC 100 would capture the interactions as events which could be chosen for a subsequent composed mode rendering of the lecture.

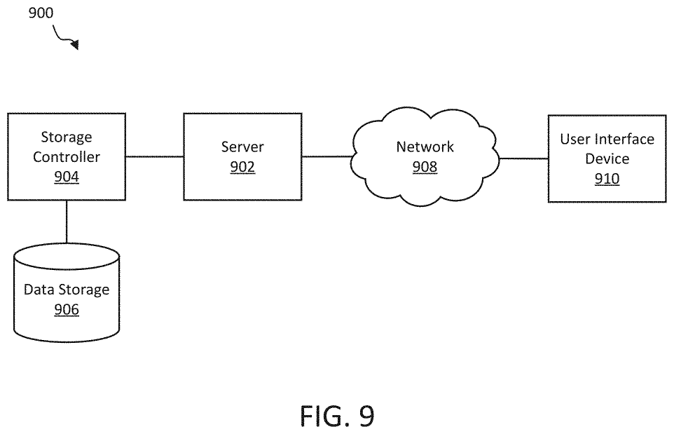

FIG. 9 illustrates one embodiment of a system 900 for an information system, which may host virtual machines. The system 900 may include a server 902, a data storage device 906, a network 908, and a user interface device 910. The server 902 may be a dedicated server or one server in a cloud computing system. The server 902 may also be a hypervisor-based system executing one or more guest partitions. The user interface device 910 may be, for example, a mobile device operated by a tenant administrator. In a further embodiment, the system 900 may include a storage controller 904, or storage server configured to manage data communications between the data storage device 906 and the server 902 or other components in communication with the network 908. In an alternative embodiment, the storage controller 904 may be coupled to the network 908.

In one embodiment, the user interface device 910 is referred to broadly and is intended to encompass a suitable processor-based device such as a desktop computer, a laptop computer, a personal digital assistant (PDA) or tablet computer, a smartphone or other a mobile communication device having access to the network 908. The user interface device 910 may be used to access a web service executing on the server 902. When the device 910 is a mobile device, sensors (not shown), such as a camera or accelerometer, may be embedded in the device 910. When the device 910 is a desktop computer the sensors may be embedded in an attachment (not shown) to the device 910. Ina further embodiment, the user interface device 910 may access the Internet or other wide area or local area network to access a web application or web service hosted by the server 902 and provide a user interface for enabling a user to enter or receive information.

The network 908 may facilitate communications of data, such as dynamic license request messages, between the server 902 and the user interface device 910. The network 908 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 910 accesses the server 902 through an intermediate sever (not shown). For example, in a cloud application the user interface device 910 may access an application server. The application server may fulfill requests from the user interface device 910 by accessing a database management system (DBMS). In this embodiment, the user interface device 910 may be a computer or phone executing a Java application making requests to a JBOSS server executing on a Linux server, which fulfills the requests by accessing a relational database management system (RDMS) on a mainframe server.

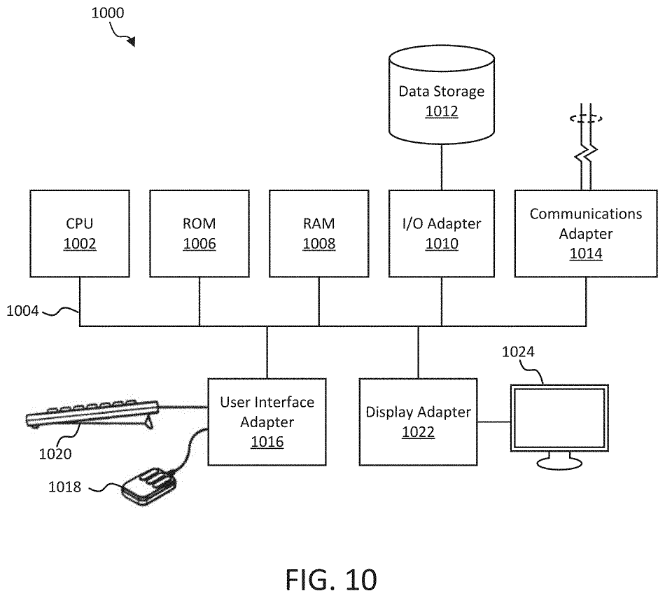

FIG. 10 illustrates a computer system 1000 adapted according to certain embodiments of the server 902 and/or the user interface device 910. The central processing unit (“CPU”) 1002 is coupled to the system bus 1004. The CPU 1002 may be a general purpose CPU or microprocessor, graphics processing unit (“GPU”), and/or microcontroller. The present embodiments are not restricted by the architecture of the CPU 1002 so long as the CPU 1002, whether directly or indirectly, supports the operations as described herein. The CPU 1002 may execute the various logical instructions according to the present embodiments.

The computer system 1000 also may include random access memory (RAM) 1008, which may be synchronous RAM (SRAM), dynamic RAM (DRAM), synchronous dynamic RAM (SDRAM), or the like. The computer system 1000 may utilize RAM 1008 to store the various data structures used by a software application. The computer system 1000 may also include read only memory (ROM) 1006 which may be PROM, EPROM, EEPROM, optical storage, or the like. The ROM may store configuration information for booting the computer system 1000. The RAM 1008 and the ROM 1006 hold user and system data, and both the RAM 1008 and the ROM 1006 may be randomly accessed.

The computer system 1000 may also include an input/output (I/O) adapter 1010, a communications adapter 1014, a user interface adapter 1016, and a display adapter 1022. The I/O adapter 1010 and/or the user interface adapter 1016 may, in certain embodiments, enable a user to interact with the computer system 1000. In a further embodiment, the display adapter 1022 may display a graphical user interface (GUI) associated with a software or web-based application on a display device 1024, such as a monitor or touch screen.

The I/O adapter 1010 may couple one or more storage devices 1012, such as one or more of a hard drive, a solid state storage device, a flash drive, a compact disc (CD) drive, a floppy disk drive, and a tape drive, to the computer system 1000. According to one embodiment, the data storage 1012 may be a separate server coupled to the computer system 1000 through a network connection to the I/O adapter 1010. The communications adapter 1014 may be adapted to couple the computer system 1000 to the network 1008, which may be one or more of a LAN, WAN, and/or the Internet. The communications adapter 1014 may also be adapted to couple the computer system 1000 to other networks such as a global positioning system (GPS) or a Bluetooth network. The user interface adapter 1016 couples user input devices, such as a keyboard 1020, a pointing device 1018, and/or a touch screen (not shown) to the computer system 1000. The keyboard 1020 may be an on-screen keyboard displayed on a touch panel. Additional devices (not shown) such as a camera, microphone, video camera, accelerometer, compass, and or gyroscope may be coupled to the user interface adapter 1016. The display adapter 1022 may be driven by the CPU 1002 to control the display on the display device 1024. Any of the devices 1002-1022 may be physical and/or logical.

The applications of the present disclosure are not limited to the architecture of computer system 1000. Rather the computer system 1000 is provided as an example of one type of computing device that may be adapted to perform the functions of a server 902 and/or the user interface device 910. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 1000 may be virtualized for access by multiple users and/or applications. The applications could also be performed in a serverless environment, such as the cloud.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. A serverless environment, such as the cloud, could also be used.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. A serverless environment, such as the cloud, could also be used.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

We claim:

1. A method of decomposing a lecture into events, the method comprising:
processing a recorded video and segmenting the video into video, chat, audio and audio transcript;
processing the video and dividing it into discreet events including lecture, green board text, white board text, and interaction with users; and
storing the discreet events as a storyboard that identifies break points in the lecture;
wherein the storyboard and events can be used to create a composed lecture.

2. The method of claim 1, further comprising after the composed lecture is created, a new discreet event can be added to the storyboard.

3. The method of claim 1, further comprising after the composed lecture is created, a new discreet event can replace a discreet event in the storyboard.

4. The method of claim 1, further comprising after the composed lecture is created, editing the storyboard to create a new composed lecture.

5. The method of claim 1, further comprising presentation the composed lecture as a virtual presentation.

6. The method of claim 5, further comprising determining if a first user creates a new event during the presentation, and if so, storing the new event in the storyboard.

7. The method of claim 6, further comprising creating a second composed lecture from the discreet events and the new event.

8. The method of claim 7, further comprising presenting the second composed lecture to a second user.

9. The method of claim 5, further comprising after receiving a question from a user, pausing the composed lecture and sending the question to a resource outside of the composed lecture to answer the question.

10. The method of claim 9, further comprising storing the answer as a discreet event in the storyboard.

11. A computer program product, comprising:
a non-transitory computer readable medium comprising instructions which, when executed by a processor of a computing system, cause the processor to perform the steps of:
processing a recorded video and segmenting the video into video, chat, audio and audio transcript;
processing the video and dividing it into discreet events including lecture, green board text, white board text, and interaction with users; and
storing the discreet events as a storyboard that identifies break points in the lecture;
wherein the storyboard and events can be used to create a composed lecture.

12. The computer program product of claim 11, further comprising after the composed lecture is created, a new discreet event can be added to the storyboard.

13. The computer program product of claim 11, further comprising after the composed lecture is created, a new discreet event can replace a discreet event in the storyboard.

14. The computer program product of claim 11, further comprising after the composed lecture is created, editing the storyboard to create a new composed lecture.

15. The computer program product of claim 11, further comprising presentation the composed lecture as a virtual presentation.

16. The computer program product of claim 15, further comprising determining if a first user creates a new event during the presentation, and if so, storing the new event in the storyboard.

17. The computer program product of claim 16, further comprising creating a second composed lecture from the discreet events and the new event.

18. The computer program product of claim 17, further comprising presenting the second composed lecture to a second user.

19. The computer program product of claim 15, further comprising after receiving a question from a user, pausing the composed lecture and sending the question to a resource outside of the composed lecture to answer the question.

20. The computer program product of claim 19, further comprising storing the answer as a discreet event in the storyboard.
